(19) United States
(12) Patent Application Publication
(10) Pub. No.: US 2008/0111469 A1
(43) Pub. Date: May 15, 2008

(54) LIGHT EMISSION DEVICE AND DISPLAY DEVICE

(76) Inventors: Kyu-Won Jung, Yongin-si (KR); Sang-Jin Lee, Yongin-si (KR); Yong-Gun Won, Yongin-si (KR); Il-Hwan Kim, Yongin-si (KR); Seung-Hyun Lee, Yongin-si (KR)

Correspondence Address: CHRISTIE, PARKER & HALE, LLP, PO BOX 7068, PASADENA, CA, 91109-7068, US

(21) Appl. No.: 11/759,167

(22) Filed: Jun. 6, 2007

(30) Foreign Application Priority Data
Nov. 14, 2006 (KR) 10-2006-0112206

(51) Int. Cl. H01J 1/62

(52) U.S. Cl. 313/496

(57) ABSTRACT

A light emission device and a display device using the light emission device as light source are provided. The light emission device includes a vacuum vessel including a first substrate, a second substrate and a sealing member disposed between the first and second substrates; an electron emission unit on a side of the first substrate facing the second substrate; a light emission unit, including an anode electrode and a phosphor layer, on a side of the second substrate facing the first substrate and spaced apart from the sealing member; and a first resistive layer for absorbing an arc current, wherein the first resistive layer is on the side of the second substrate at an inside region of the vacuum vessel, the inside region being defined by the sealing member.

### CROSS-REFERENCE TO RELATED APPLICATION

This application claims priority to and the benefit of Korean Patent Application No. 10-2006-0112206, filed on Nov. 14, 2006, in the Korean Intellectual Property Office, the entire content of which is incorporated herein by reference.

### BACKGROUND OF THE INVENTION

1. Field of the Invention

The present invention relates to a light emission device and/or a display device using the light emission device as a light source.

2. Description of the Related Art

Devices that can emit light to an external side can be referred to as light emission devices. In one embodiment, a light emission device includes a rear substrate on which an electron emission unit is formed and a front substrate on which a light emission unit is formed. The electron emission unit includes electron emission regions and driving electrodes. The light emission unit includes an anode electrode and a phosphor layer.

A sealing member is provided at peripheries (or periphery regions) of the rear and front substrates to seal them together, thus forming a vacuum vessel. The light emission device emits visible light by exciting the phosphor layer using electrons emitted from the electron emission regions.

The light emission device is operated by i) controlling an amount of electrons emitted from the electron emission regions by applying driving voltages to the driving electrodes and ii) accelerating the electrons emitted from the electron emission regions toward the phosphor layer by applying a positive direct current voltage (anode voltage) ranging from hundreds to thousands of volts to the anode electrode. The light emission device can be used as a light source in a display device having a non-self emissive display panel.

Here, the anode electrode is connected to an anode lead that extends out of the sealing member to be connected to an anode circuit unit. The anode circuit unit applies the anode voltage to the anode electrode through the anode lead.

The luminance of the light emission device is proportional to the anode voltage. Therefore, the luminance of the light emission device is enhanced by increasing the anode voltage. However, as the anode voltage increases, it is likely to generate arcing of electrons in the vacuum vessel. When the arcing is generated, the light emission unit may be damaged, or a high current may flow to the anode circuit unit along the anode lead to damage the anode circuit unit.

Furthermore, in a conventional light emission device, since the entire light emission area emits light with a constant luminance when the display device is driven, it is difficult to improve the contrast ratio and this it is difficult to improve the display quality.

### SUMMARY OF THE INVENTION

Aspects of embodiments of the present invention are directed to a light emission device having a light emission unit adapted to endure arching of electrons and/or a display device using the light emission device as a light source.

Other aspects of embodiments of the present invention are directed to a light emission device that can improve luminance of a light emission area by increasing an anode voltage and protect (or prevent) a light emission unit and an anode circuit unit from being damaged, and/or a display device using the light emission device as a light source.

Other aspects of embodiments of the present invention are directed to a light emission device that can independently control light intensities of a plurality of divided regions of a light emission area, and/or a display device that can enhance contrast ratio of display images by using the light emission device as a light source.

According to an embodiment of the present invention, a light emission device includes: a vacuum vessel including a first substrate, a second substrate and a sealing member disposed between the first and second substrates; an electron emission unit on a side of the first substrate facing the second substrate; a light emission unit, including an anode electrode and a phosphor layer, on a side of the second substrate facing the first substrate and spaced apart from the sealing member; and a first resistive layer for absorbing an arc current, wherein the first resistive layer is on the side of the second substrate at an inside region of the vacuum vessel, the inside region being defined by the sealing member.

In one embodiment, the light emission device further includes a second resistive layer on the side of the second substrate between the light emission unit and the first resistive layer, wherein a resistance of the second resistive layer is lower than that of the first resistive layer.

In one embodiment, the second resistive layer is disposed along an edge of the light emission unit to contact the anode electrode, and the first resistive layer is disposed along an edge of the second resistive layer to contact the second resistive layer.

In one embodiment, the light emission device further includes an anode lead extending from the second resistive layer to an outside region of the vacuum vessel, the outside region being defined by the sealing member, and wherein the first resistive layer covers a portion of the anode lead disposed at the inside region of the vacuum vessel.

In one embodiment, the light emission device further includes an anode lead contacting the first resistive layer at an outer side of the first resistive layer, a part of the anode lead being exposed to an outside region of the vacuum vessel, the outside region being defined by the sealing member.

In one embodiment, the light emission device further includes an anode button penetrating the second substrate at the inside region of the vacuum vessel and spaced apart from the light emission unit. The light emission device may further include an anode lead extending from the second resistive layer and contacting the anode button, wherein the first resistive layer covers the anode lead.

In one embodiment, the first resistive layer has a resistance within a range of 10 to 500 kΩ, and the second resistive layer has a resistance within a range of 1 to 50 Ω.

In one embodiment, the first resistive layer includes graphite, the second resistive layer includes a metal material selected from the group consisting of silver, nickel, aluminum, and combinations thereof, and the first and second resistive layers are thick film resistive layers.

According to another exemplary embodiment of the present invention, a display device includes a display panel for displaying an image and a light emission device for emitting light toward the display panel. The light emission device includes: a vacuum vessel including a first substrate, a second substrate and a sealing member disposed between the first and second substrates; an electron emission unit on a side of the first substrate facing the second substrate; a light emission unit, including an anode electrode and a phosphor layer, on a side of the second substrate facing the first substrate and spaced apart from the sealing member; and a first resistive layer for absorbing an arc current, the first resistive layer being on the side of the second substrate at an inside region of the vacuum vessel, the inside region being defined by the sealing member.

In one embodiment, the light emission device further includes a second resistive layer on the side of the second substrate between the light emission unit and the first resistive layer, wherein a resistance of the second resistive layer is lower than that of the first resistive layer.

In one embodiment, the light emission device further includes an anode lead extending from the second resistive layer to an outside region of the vacuum vessel, the outside region being defined by the sealing member, and wherein the first resistive layer covers a portion of the anode lead disposed at the inside region of the vacuum vessel.

In one embodiment, the light emission device further includes an anode lead contacting the first resistive layer at an outer side of the first resistive layer, a part of the anode lead being exposed to an outside region of the vacuum vessel, the outside region being defined by the sealing member.

In one embodiment, the light emission device further includes an anode button penetrating the second substrate at the inside region of the vacuum vessel and spaced apart from the light emission unit. The light emission device may further include an anode lead extending from the second resistive layer and contacting the anode button, wherein the first resistive layer covers the anode lead.

In one embodiment, the first resistive layer has a resistance within a range of 10 to 500 kΩ, and the second resistive layer has a resistance within a range of 1 to 50 Ω.

In one embodiment, the display panel includes a plurality of first pixels, the light emission device includes a plurality of second pixels, the second pixels are less in number than that of the first pixels, and light emission intensities of the second pixels are independently controlled. The display panel may be a liquid crystal display panel.

According to another embodiment of the present invention, a light emission device includes: a first substrate; a second substrate; a sealing member disposed between the first and second substrates; an electron emission unit on a side of the first substrate facing the second substrate; a light emission unit, including an anode electrode and a phosphor layer, on a side of the second substrate facing the first substrate and spaced apart from the sealing member; and a first resistive layer, for absorbing an arc current, on the side of the second substrate at a region between the sealing member and the light emission unit.

In one embodiment, the light emission device further includes a second resistive layer on the side of the second substrate between the light emission unit and the first resistive layer, wherein a resistance of the second resistive layer is lower than that of the first resistive layer. The first resistive layer may have a resistance within a range of 10 to 500 kΩ, and the second resistive layer may have a resistance within a range of 1 to 50 Ω.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a partial sectional view of a light emission device according to an exemplary embodiment of the present invention.

FIG. 2 is a partial exploded perspective view of the light emission device of FIG. 1.

FIG. 3 is a perspective schematic view of a second substrate of the light emission device of FIG. 1 in which an inner surface of the second substrate is oriented upward.

FIG. 4 is a perspective schematic view of a second substrate illustrating another exemplary embodiment of an anode lead of FIG. 3.

FIG. 5 is a partial sectional view of a light emission device according to another exemplary embodiment of the present invention.

FIG. 6 is a perspective schematic view of a second substrate of the light emission device of FIG. 5 in which an inner surface of the second substrate is oriented upward.

FIG. 7 is a partial exploded perspective view of a display device according to an exemplary embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

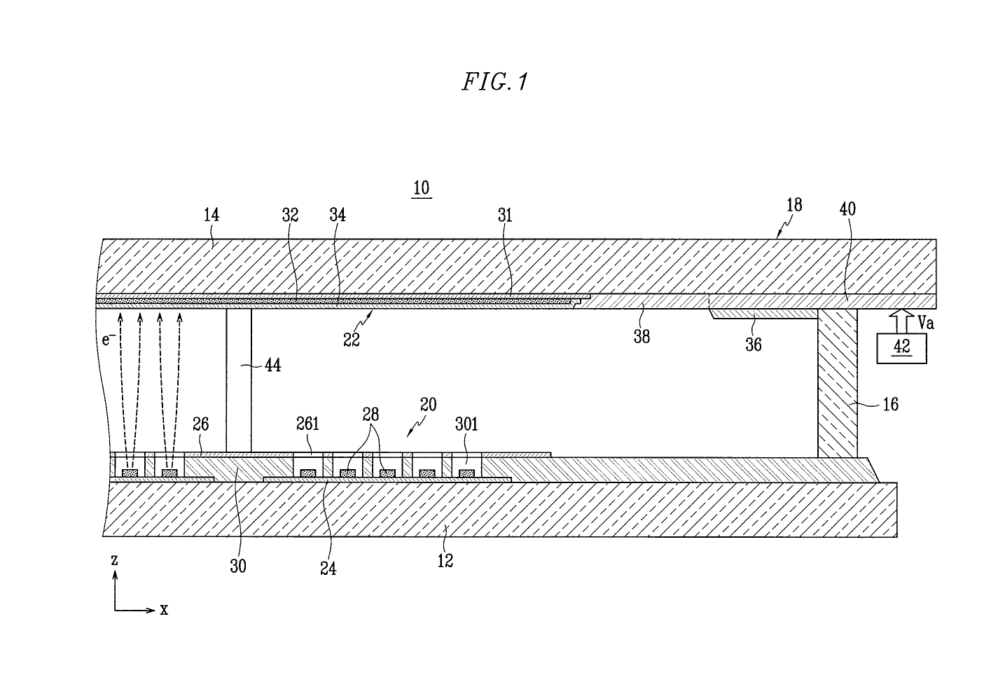

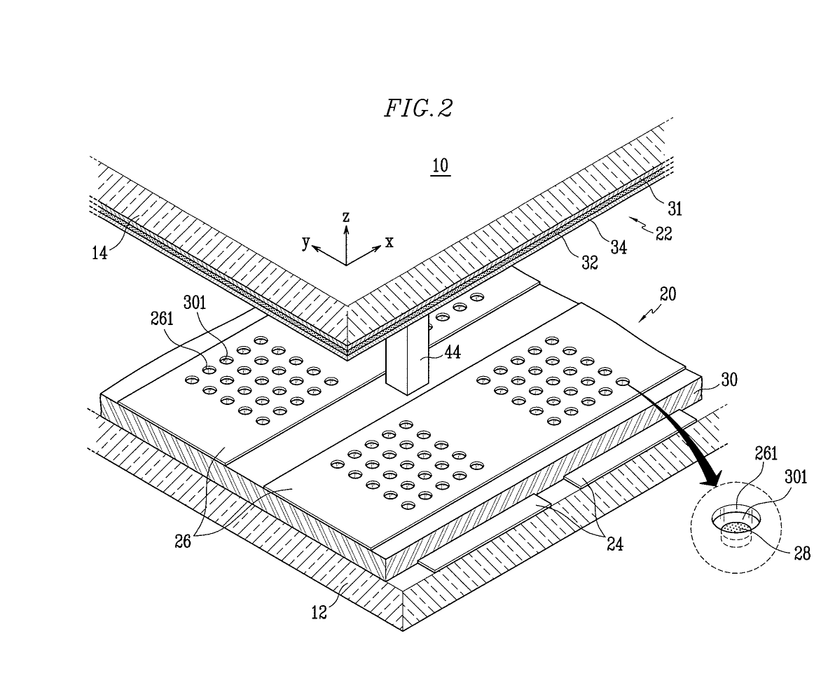

FIG. 1 is a partial sectional view of a light emission device 10 according to an exemplary embodiment of the present invention and FIG. 2 is a partial exploded perspective view of the light emission device 10 of FIG. 1.

Referring to FIGS. 1 and 2, the light emission device 10 of the present embodiment includes first and second substrates 12 and 14 facing each other in parallel (or in a substantially parallel manner) with an gap (that may be predetermined) therebetween. A sealing member 16 is provided at the peripheries (or periphery regions) of the first and second substrates 12 and 14 to seal them together, thus forming a vacuum vessel 18. The interior of the vacuum vessel 18 is kept to a degree of vacuum of about 10⁻⁶ Torr.

Each of the first and second substrates 12 and 14 has an active area for contributing to the emission of visible light and a non-active area for surrounding the active area within a region surrounded by the sealing member 16. An electron emission unit 20 for emitting electrons is provided on an inner surface of the first substrate 12 at the active area (e.g., is provided on a side of the first substrate 12 facing the second substrate 14), and a light emission unit 22 for emitting visible light is provided on an inner surface of the second substrate 14 at the active area (e.g., is provided on a side of the second substrate 14 facing the first substrate 12).

The electron emission unit 20 includes a plurality of electron emission elements, such as Field Emission Array (FEA) type elements, Surface-Conduction Emission (SCE) type elements, Metal-Insulator-Metal (MIM) type elements, and Metal-Insulator-Semiconductor (MIS) type elements. In FIGS. 1 and 2, an example where the electron emission unit is composed of the FEA type elements is illustrated. However, the present invention is not limited to this example.

The electron emission unit 20 includes first electrodes 24 and second electrodes 26 insulated from each other, and electron emission regions 28 electrically connected to the first electrodes 24.

The first electrodes 24 connecting the electron emission regions 28 are cathode electrodes for applying a current to the electron emission regions 28, and the second electrodes 26 insulated from the electron emission regions 28 are gate electrodes for inducing the electron emission by forming an electric field around the electron emission regions 28 according to a voltage difference between the cathode and gate electrodes.

The first electrodes 24 are formed in a stripe pattern along one direction of the first substrate 12. The second electrodes 26 are formed in a stripe pattern along another direction of the first substrate 12 to cross the first electrodes 24. An insulating layer 30 is interposed between the first electrodes 24 and the second electrodes 26.

Openings 261 and 301 are formed in the second electrodes 26 and the insulating layer 30 at each crossed region (or crossing region) of the first and second electrodes 24 and 26 to partly expose the surface of the first electrodes 24 and the electron emission regions 28 are formed on the exposed portions of the first electrodes 24 through the openings 301 of the insulating layer 30.

Among the first and second electrodes 24 and 26, the electrodes (e.g., the second electrodes 26) parallel to the row direction (x-axis direction shown in FIG. 2) of the light emission device 10 may be applied with a scan driving voltage to function as scan electrodes, and the electrodes (e.g., the first electrodes 24) parallel to the column direction (y-axis direction shown in FIG. 2) of the light emission device 10 may be applied with a data driving voltage to function as data electrodes.

The electron emission regions 28 are formed of a material for emitting electrons when an electric field is applied thereto under a vacuum atmosphere, such as a carbon-based material and/or a nanometer-sized material. For example, the electron emission regions 28 may be formed of carbon nanotubes, graphite, graphite nanofibers, diamonds, diamond-like carbon, C₆₀, silicon nanowires or combinations thereof.

Alternatively, the electron emission regions may be formed to have a pointed-tip structure using a Mo-based material and/or a Si-based material.

One crossed region of the first and second electrodes 24 and 26 may correspond to one pixel region of the light emission device 10. Alternatively, two or more crossed regions of the first and second electrodes 24 and 26 may correspond to one pixel region of the light emission device 10. In latter case, two or more first electrodes 24 and/or two or more second electrodes 26 that are placed in one pixel region are electrically connected to each other to receive a common drive voltage.

The light emission unit 22 includes an anode electrode 31 and a phosphor layer 32 located on one side of the anode electrode 31. The phosphor layer 32 may be formed of a mixture of red, green, and blue phosphors to emit white light. The phosphor layer 32 may be formed on an entire active area of the second substrate 14 or in a pattern (or a predetermined pattern) having a plurality of sections corresponding to pixel regions. In the present embodiment, a case where the phosphor layer 32 is formed on the entire active area of the second substrate 14 is illustrated as an example.

The anode electrode 31 is formed by a transparent conductive material such as indium tin oxide (ITO). The anode electrode 31 is an acceleration electrode that pulls electrons emitted from the electron emission regions 28 toward the phosphor layer 32 by receiving a high voltage (anode voltage).

The phosphor layer 32 may be covered by a metal reflective layer 34. The metal reflective layer 34 functions to enhance the luminance by reflecting the visible light, which is emitted from the phosphor layer 32 to the first substrate 12, back toward the second substrate 14. The anode electrode 31 can be omitted and the metal reflective layer 34 can receive the anode voltage instead of the anode electrode 31 (i.e., the metal reflective layer 34 can be (or function as) the anode electrode).

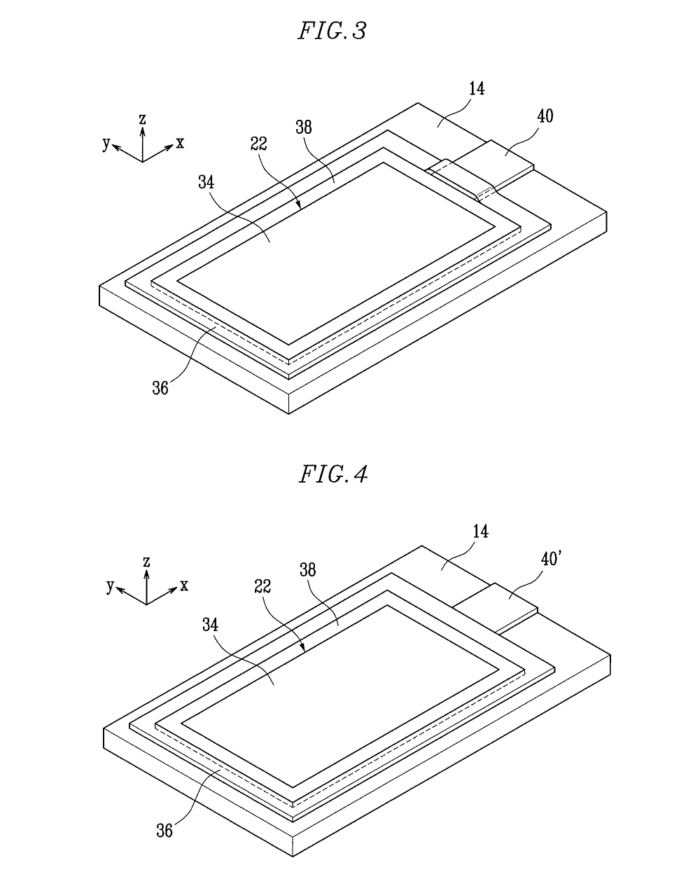

FIG. 3 is a perspective schematic view of the second substrate 14 in which the inner surface of the second substrate 14 is oriented upward (e.g., the side of the second substrate 14 facing the first substrate 12 is oriented upward).

Referring to FIGS. 1 and 3, first and second resistive layers 36 and 38 are formed on the inner surface of the second substrate 14 at the non-active area to apply the anode voltage to the anode electrode 31 and enhance the high voltage stability of the light emission unit 22.

The first resistive layer 36 has a resistance from tens to hundreds of kilo-ohms (kΩ) while the second resistive layer 38 has a resistance of several ohms. Therefore, the first resistive layer 36 may be called a high resistive layer while the second resistive layer 38 may be called a low resistive layer.

In more detail, the first resistive layer 36 has a width (or a predetermined width). The first resistive layer 36 is formed on the non-active area of the inner surface of the second substrate 14 along an edge (or edge region) adjacent to an inner wall of the sealing member 16 and spaced apart from the light emission unit 22 by a distance (or a predetermined distance). The second resistive layer 38 is formed along an edge (or edge region) of the light emission unit 22 with a width (or a predetermined width) between the light emission unit 22 and the first resistive layer 36.

The second resistive layer 38 is electrically connected to the anode electrode 31 by contacting a side surface of the anode electrode 31, or by covering the entire side surface and a part of the top surface of the anode electrode 31. The first resistive layer 36 is electrically connected to the second resistive layer 38 by contacting a side surface of the second resistive layer 38 or by covering the entire side surface and a part of the top surface of the second resistive layer 38.

A portion of the second resistive layer 38 may extend out of the sealing member 16 to form an anode lead 40. Here, the first resistive layer 36 may cover the portion of the anode lead 40 that is disposed at an inside region of the vacuum vessel 18 defined by the sealing member 16 so that the portion of the anode lead 40 is not exposed to the first substrate 12. The anode lead 40 is connected to the anode circuit unit 42 to receive the anode voltage Va from the anode circuit unit 42.

The first resistive layer 36 may have a resistance within a range of 1 to 500 k Ω to absorb a high current when an arc discharge is generated in the vacuum vessel 18, thereby suppressing a damage of the light emission unit 22 and the anode circuit unit 42, which may be caused by the arcing current, by absorbing the high current. The second resistive layer 38 may have a resistance within a range of 1 to 50Ω. The second resistive layer 38 reduces (or minimizes) the anode voltage loss and transmits the anode voltage applied from the anode circuit unit 42 to the anode electrode 31.

The first resistive layer 36 may include a conductive material such as graphite. The second resistive layer 38 may include a metal material selected from the group consisting of Ag, Ni, Al, and combinations thereof. The first and second resistive layers 36 and 38 may be formed through a thick film process such as a screen-printing process.

The thick film process, such as the screen-printing process, is a relatively simple process that can easily control resistance values of the first and second resistive layers 36 and 38 by controlling an amount of the conductive material (e.g., the graphite for the first resistive layer 36 and the metal material for the second resistive layer 38) contained in a paste of the thick film process.

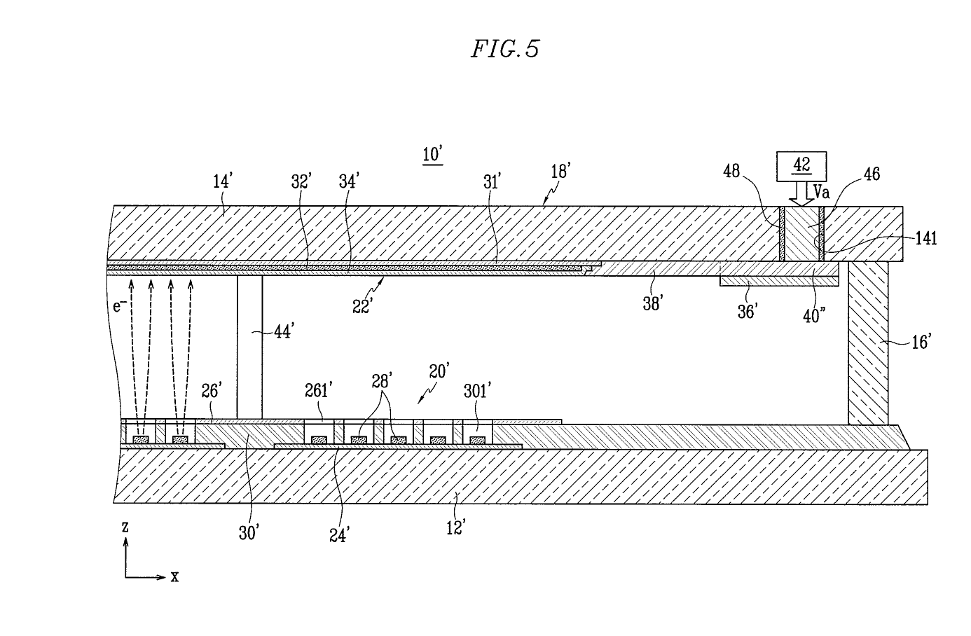

Alternatively, as shown in FIG. 4, the anode lead 40′ may not be connected to the second resistive layer 38 but electrically contacts a side surface of the first resistive layer 36 at an outer side of the first resistive layer 36. That is, the anode electrode 31 can receive the anode voltage through the anode lead 40′, the first resistive layer 36 and the second resistive layer 38.

In this case and according to an embodiment of the present invention, although the resistance of the first resistive layer 36 is greater than that of the second resistive layer 38, the high voltage (e.g., above 10 kV) applied to the anode lead 40′ and the configuration of the width of the first resistive layer 36 reduce (or minimize or prevent) a significant voltage drop. Therefore, in this embodiment, the actual anode voltage loss due to the first resistive layer 36 can be ignored (i.e., the actual anode voltage loss due to the first resistive layer 36 is relatively low).

Referring to FIGS. 1 and 2, disposed between the first and second substrates 12 and 14 are spacers 44 for uniformly maintaining a gap between the first and second substrates 12 and 14 against an outer force (or pressure). The first and second substrates 12 and 14 facing each other are spaced apart from each other by a gap ranging from about 5 to 20 mm. A height of each spacer 44 corresponds to the gap between the first and second substrates 12 and 14. For convenience of description purposes, only one spacer 44 is shown in FIGS. 1 and 2.

The light emission device 10 has a plurality of pixels formed by the combination of the first and second electrodes 24 and 26. The light emission device 10 is driven by applying a drive (or driving) voltage (that may be predetermined) to the first and second electrodes 24 and 26 and by applying the anode voltage that is above 10 kV, and, in one embodiment, from about 1° to 15 kV, to the anode electrode 31.

Then, electric fields are formed around the electron emission regions 28 at the pixels where a voltage difference between the first and second electrodes 24 and 26 is equal to or higher than a threshold value and thus the electrons are emitted from the electron emission regions 28. The emitted electrons strike the phosphor layer 32 of the corresponding pixel by being attracted by the anode voltage applied to the anode electrode 31, thereby exciting the phosphor layers 32 to realize one or more images. The light emission intensities of the phosphor layers 32 of the respective pixels correspond to the amount of electron emissions of the respective pixels.

When the anode voltage that is above 10 kV is applied to the anode electrode 31, the light emission device 10 with the above-described internal structure of the present embodiment can realize a luminance at above 10,000 cd/m² at a central portion of the active (or light emission) area.

In the light emission device 10 of this embodiment, even when arcing is generated in the vacuum vessel 18, the first resistive layer 36 formed on the inner surface of the second substrate 14 at the non-active area absorbs the high current, and thus the damage of the light emission unit 22 and the anode circuit unit 42 can be reduced (or prevented). As a result, the durability of the light emission device is enhanced and a malfunction of the light emission device 10 can be reduced (or minimized).

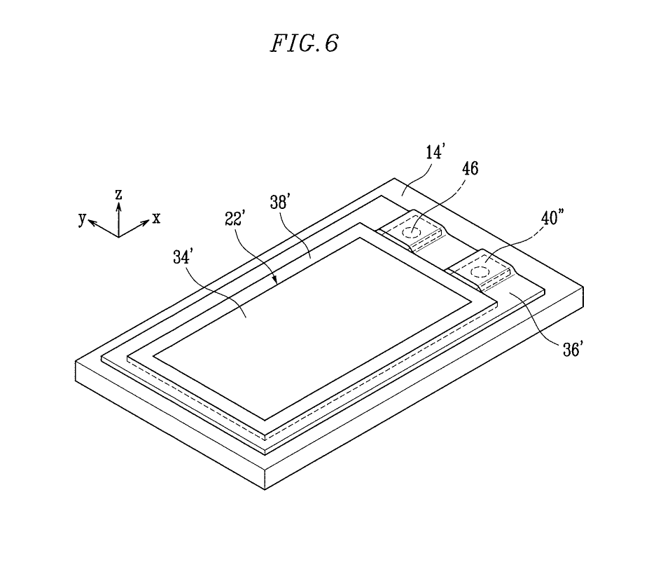

FIG. 5 is a partial sectional view of a light emission device 10′ according to another exemplary embodiment of the present invention, and FIG. 6 is a perspective schematic view of a second substrate 14′ of the light emission device 10′ of FIG. 5 in which an inner surface of the second substrate 14′ is oriented upward.

Referring to FIGS. 5 and 6, an anode electrode 31′ of a light emission device 10′ receives an anode voltage Va through an anode button 46 penetrating a second substrate 14′ at a non-active area at (or near) an inside region of a vacuum vessel 18′, the inside region being defined by the sealing member 16′.

That is, the second substrate 14′ is provided with an opening 141 formed through the non-active area at (or near) the inside region of the vacuum vessel 18′, the inside region being defined by the sealing member 16′. In addition, the opening 141 is filled with the anode button 46 and fixed on the second substrate 14′. An adhesive layer 48 formed of glass frit is formed around the anode button 46 to provide air-tightness between the second substrate 14′ and the anode button 46.

A first resistive layer 36′ may cover an anode lead 40″ extending from a second resistive layer 38′ so that the anode lead 40″ is not exposed to the first substrate 12′. The anode button 46 is connected to an anode circuit unit 42′ to receive the anode voltage Va from the anode circuit unit 42′. In FIG. 6, two anode leads 40″ are shown with two anode buttons 46, but the present invention is not thereby limited (e.g., embodiments of the present invention may include only one anode lead with one anode button or may include three or more anode leads with three or more anode buttons).

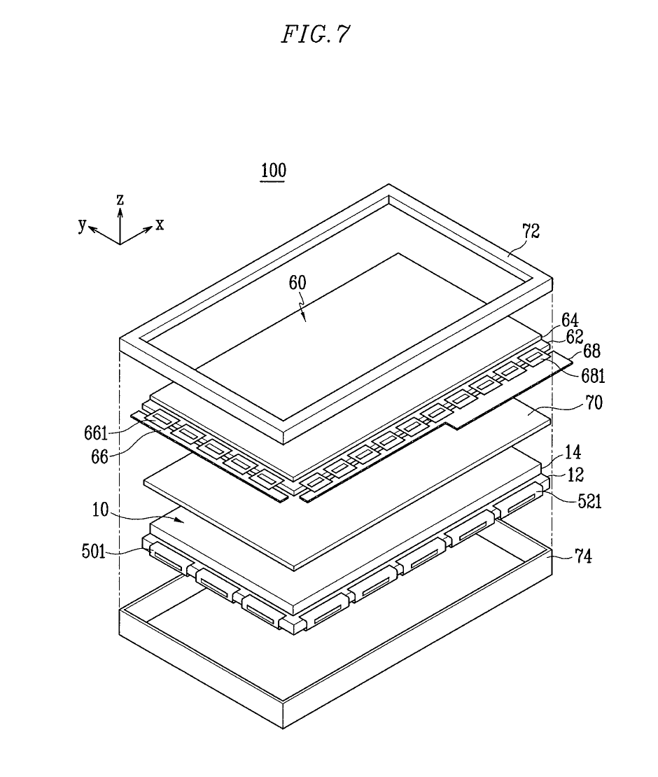

FIG. 7 is an exploded perspective view of a display device 100 employing (or including) the light emission device 10 of the exemplary embodiment of FIG. 1 or the light mission device 10′ of the exemplary embodiment of FIG. 5 as a light source. The display device 100 of FIG. 7 is provided as an exemplary embodiment of the present invention, and is not intended to limit the present invention.

Referring to FIG. 7, the display device 100 of this embodiment includes the light emission device 10 (or 10′) and a display panel 60 disposed on (or in front) of the light emission device 10. A diffuser 70 for uniformly diffusing the light emitted from the light emission device 10 toward the display panel 60 may be disposed between the display panel 60 and the light emission device 10. The diffuser 70 is spaced apart from the light emission device 10 by a distance (that may be predetermined). A top chassis 72 is disposed in front the display panel 60 and a bottom chassis 74 is disposed in rear of the light emission device 10.

The display panel 60 may be a liquid crystal display panel or other non-self emissive display panels. In the following description, the liquid crystal display panel is described in more detail as an example, but the present invention is not thereby limited.

The display panel 60 includes a thin film transistor (TFT) substrate 62 composed of a plurality of TFTs, a color filter substrate 64 disposed on the TFT substrate 62, and a liquid crystal layer disposed between the TFT substrate 62 and the color filter substrate 64. Polarizer plates are attached on a top (or upper) surface of the color filter substrate 64 and a bottom (or rear) surface of the TFT substrate 62 to polarize the light passing through the display panel 60.

The TFT substrate 62 is a glass plate on which the TFTs are arranged in a matrix pattern. A data line is connected to a source terminal of the TFT (i.e., at least one of the TFTs), and a gate line is connected to a gate terminal of the TFT. A pixel electrode formed of a transparent conductive layer is connected to a drain terminal of the TFT.

When electric signals are inputted from circuit board assemblies 66 and 68 to the respective gate and data lines, electric signals are inputted to the gate and source terminals of the TFT. Then, the TFT turns on or off according to the electric signals inputted thereto, and outputs an electric signal required for driving the pixel electrode to the drain terminal.

Red, green, and blue color filters are formed on the color filter substrate 64 so as to emit various colors (or predetermined colors) as the light passes through the color filter substrate 64. A common electrode formed of a transparent conductive layer is deposited on an entire surface of the color filter substrate 64.

When electric signal is applied to the gate and source terminals of the TFTs to turn on the TFTs, an electric field is formed between the pixel electrode (or pixel electrodes) and the common electrode. Due to the electric field, the orientation angle of liquid crystal molecules of the liquid crystal layer varies and thus the light transmissivity of each pixel varies according to the varied orientation angle of the liquid crystal molecules.

The circuit board assemblies 66 and 68 of the display panel 60 are connected to drive IC packages 661 and 681, respectively. In order to drive the display panel 60, the gate circuit board assembly 66 transmits a gate drive signal and the data circuit board assembly 68 transmits a data drive signal.

The number of pixels of the light emission device 10 is less than that of the display panel 60 so that one pixel of the light emission device 10 corresponds to two or more pixels of the display panel 60. Each pixel of the light emission device 10 emits light in response to the highest gray level (or gray level value) among the corresponding pixels of the display panel 60. The light emission device 10 can represent gray levels in gray scale ranging from 2 to 8 bits for each of the pixels of the light emission device 10.

For purposes of convenience of description, the pixels of the display panel 60 will be referred to as first pixels and the pixels of the light emission device 10 will be referred to as second pixels. In addition, a plurality of first pixels corresponding to one second pixel will be referred to as a first pixel group.

In order to drive the light emission device 10, a signal control unit for controlling the display panel 60 detects a highest gray level among the first pixels of the first pixel group, calculates a gray level required for the light emission of the second pixel according to the detected gray level, converts the calculated gray level into digital data, and generates a driving signal of the light emission device 10 using the digital data. The drive signal of the light emission device 10 includes a scan drive signal and a data drive signal.

Printed circuit boards, that is a scan printed circuit board and a data printed circuit board of the light emission device 10, are connected to drive IC packages 501 and 521, respectively. In order to drive the light emission device 10, the scan printed circuit board transmits a scan drive signal and the data printed circuit board transmits a data drive signal. One of the first and second electrodes (e.g., the cathode and gate electrodes) receives the scan drive signal and the other receives the data drive signal (i.e., the cathode electrode receives the scan drive signal and the gate electrode receives the data drive signal or the gate electrode receives the scan drive signal and the cathode electrode receives the data drive signal).

Therefore, when an image is displayed by the first pixel group, the corresponding second pixel of the light emission device 10 is synchronized with the first pixel group to emit the light with a certain gray level (that may be predetermined). The light emission device 10 has pixels arranged in rows and columns. The number of pixels arranged in each row may range from 2 to 99 pixels, and the number of pixels arranged in each column may also range from 2 to 99 pixels.

As described above, in the light emission device 10, the light emission intensities of the pixels of the light emission device 10 are independently controlled to emit a proper intensity of the light to each first pixel group of the display panel 60. As a result, the display device 100 of the present embodiment can enhance the contrast ratio of the screen, thereby improving the display quality.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emission device comprising:
a vacuum vessel including a first substrate, a second substrate and a sealing member disposed between the first and second substrates;
an electron emission unit on a side of the first substrate facing the second substrate;
a light emission unit, including an anode electrode and a phosphor layer, on a side of the second substrate facing the first substrate and spaced apart from the sealing member; and
a first resistive layer for absorbing an arc current,
wherein the first resistive layer is on the side of the second substrate at an inside region of the vacuum vessel, the inside region being defined by the sealing member.

2. The light emission device of claim 1, further comprising a second resistive layer on the side of the second substrate between the light emission unit and the first resistive layer, wherein a resistance of the second resistive layer is lower than that of the first resistive layer.

3. The light emission device of claim 2, wherein the second resistive layer is disposed along an edge of the light emission unit to contact the anode electrode, and wherein the first resistive layer is disposed along an edge of the second resistive layer to contact the second resistive layer.

4. The light emission device of claim 2, further comprising an anode lead extending from the second resistive layer to an outside region of the vacuum vessel, the outside region being defined by the sealing member, and wherein the first resistive layer covers a portion of the anode lead disposed at the inside region of the vacuum vessel.

5. The light emission device of claim 2, further comprising an anode lead contacting the first resistive layer at an outer side of the first resistive layer, a part of the anode lead being exposed to an outside region of the vacuum vessel, the outside region being defined by the sealing member.

6. The light emission device of claim 2, further comprising an anode button penetrating the second substrate at the inside region of the vacuum vessel and spaced apart from the light emission unit.

7. The light emission device of claim 6, further comprising an anode lead extending from the second resistive layer and contacting the anode button, wherein the first resistive layer covers the anode lead.

8. The light emission device of claim 2, wherein the first resistive layer has a resistance within a range of 10 to 500 kΩ, and wherein the second resistive layer has a resistance within a range of 1 to 50 Ω.

9. The light emission device of claim 8, wherein the first resistive layer comprises graphite, wherein the second resistive layer comprises a metal material selected from the group consisting of silver, nickel, aluminum, and combinations thereof, and wherein the first and second resistive layers are thick film resistive layers.

10. A display device comprising:
a display panel for displaying an image; and
a light emission device for emitting light toward the display panel,
wherein, the light emission device comprises:
a vacuum vessel including a first substrate, a second substrate and a sealing member disposed between the first and second substrates;
an electron emission unit on a side of the first substrate facing the second substrate;
a light emission unit, including an anode electrode and a phosphor layer, on a side of the second substrate facing the first substrate and spaced apart from the sealing member; and
a first resistive layer for absorbing an arc current, the first resistive layer being on the side of the second substrate at an inside region of the vacuum vessel, the inside region being defined by the sealing member.

11. The display device of claim 10, wherein the light emission device further comprises a second resistive layer on the side of the second substrate between the light emission unit and the first resistive layer, wherein a resistance of the second resistive layer is lower than that of the first resistive layer.

12. The display device of claim 11, wherein the light emission device further comprises an anode lead extending from the second resistive layer to an outside region of the vacuum vessel, the outside region being defined by the sealing member, and wherein the first resistive layer covers a portion of the anode lead disposed at the inside region of the vacuum vessel.

13. The display device of claim 11, wherein the light emission device further comprises an anode lead contacting the first resistive layer at an outer side of the first resistive layer, a part of the anode lead being exposed to an outside region of the vacuum vessel, the outside region being defined by the sealing member.

14. The display device of claim 11, wherein the light emission device further comprises:
an anode button penetrating the second substrate at the inside region of the vacuum vessel and spaced apart from the light emission unit; and
an anode lead extending from the second resistive layer and contacting the anode button,
wherein the first resistive layer covers the anode lead.

15. The display device of claim 11, wherein the first resistive layer has a resistance within a range of 10 to 500 kΩ, and wherein the second resistive layer has a resistance within a range of 1 to 50 Ω.

16. The display device of claim 10, wherein the display panel comprises a plurality of first pixels, wherein the light emission device comprises a plurality of second pixels, wherein the second pixels are less in number than that of the first pixels, and wherein light emission intensities of the second pixels are independently controlled.

17. The display device of claim 16, wherein the display panel is a liquid crystal display panel.

18. A light emission device comprising:
a first substrate;
a second substrate;
a sealing member disposed between the first and second substrates;
an electron emission unit on a side of the first substrate facing the second substrate;
a light emission unit, including an anode electrode and a phosphor layer, on a side of the second substrate facing the first substrate and spaced apart from the sealing member; and
a first resistive layer, for absorbing an arc current, on the side of the second substrate at a region between the sealing member and the light emission unit.

19. The light emission device of claim 1, further comprising a second resistive layer on the side of the second substrate between the light emission unit and the first resistive layer, wherein a resistance of the second resistive layer is lower than that of the first resistive layer.

20. The light emission device of claim 19, wherein the first resistive layer has a resistance within a range of 10 to 500 kΩ, and wherein the second resistive layer has a resistance within a range of 1 to 50 Ω.
